(19) United States
(12) Patent Application Publication
(10) Pub. No.: US 2005/0179283 A1
(43) Pub. Date: Aug. 18, 2005

(54) [CAR DUST COVER]

(75) Inventor: Chien-Hui Lin, Taipei (TW)

Correspondence Address: CHIEN-HUI LIN, 2F-4, NO. 148, SEC. 4, CHUNG HSIAD E. ROAD, TAIPEI, TW

(73) Assignee: Chien-Hui Lin, Taipei (TW)

(21) Appl. No.: 10/708,179

(22) Filed: Feb. 13, 2004

(51) Int. Cl. B60J 11/00

(52) U.S. Cl. 296/136.01

(57) ABSTRACT

A car dust cover is disclosed. The car dust cover is made of a single-piece high density PE material having an opening and a fastening element at a bottom portion thereof for covering a car.

### BACKGROUND OF INVENTION

1. The Field of the Invention

The present invention generally relates to a car dust cover, and more particularly to a single-piece car dust cover made of a high density PE material having an opening and fastening element at the bottom side thereof for substantially covering the car to substantially keep out dust and water.

2. Description of Related Art

The air pollution in the modern world causes dust and other contamination that easily cover cars. Accordingly, users buy ready-made car dust cover to avoid cars from being polluted by the air pollution.

Referring to FIG. 4, showing a conventional car dust cover A is a sewn assembly of several pieces of canvases A1 in various sizes. Such conventional car dust cover A has some defects as follows.

The conventional car dust cover A is a sewn assembly of several pieces of canvases A1 in various sizes, and therefore the manufacturing cost is high.

The conventional car dust cover A can not effectively keep out the dust and water as dust and water can easily gets through the car dust cover A through the sewing slits.

The conventional car dust cover A is stretch over a certain number of reuses, therefore the car dust cover A can easily burst after a long time usage time causes permanent damage to the car dust cover A.

Because the conventional car dust cover A is a sewn assembly of several pieces of canvases A1 and the sewing portion of the car dust cover A can not closely contact the car body, therefore the chances of dust getting into the car dust cover A is high.

The conventional car dust cover A is made of canvas, which is more expensive.

Therefore, to overcome the above defects is an important issue to the manufacturer in the field.

### SUMMARY OF INVENTION

Accordingly, in the view of the foregoing, the present inventor makes a detailed study of related art to evaluate and consider, and uses years of accumulated experience in this field, and through several experiments, to create a car dust cover. The present invention provides an innovated cost effective car dust cover.

According to an aspect of the present invention, the car dust cover is made of a single piece having an opening and fastening element at the bottom portion thereof, thus the car can be covered within the cover to substantially keep out the car from dust and water.

According to another aspect of the present invention, the fastening element of the car dust cover has a slope at one side for allowing easy and quick tightening or loosening of the fastening element.

### BRIEF DESCRIPTION OF DRAWINGS

For a more complete understanding of the present invention, reference will now be made to the following detailed description of preferred embodiments taken in conjunction with the following accompanying drawings.

FIG. 1 is a view of a car dust cover according to an embodiment of the present invention.

FIG. 2 is the elevational view of a car dust cover according to an embodiment of the present invention.

FIG. 3 is a prospective view showing the car dust cover covering a car according to an embodiment of the present invention.

FIG. 4 is a view of a conventional car dust cover.

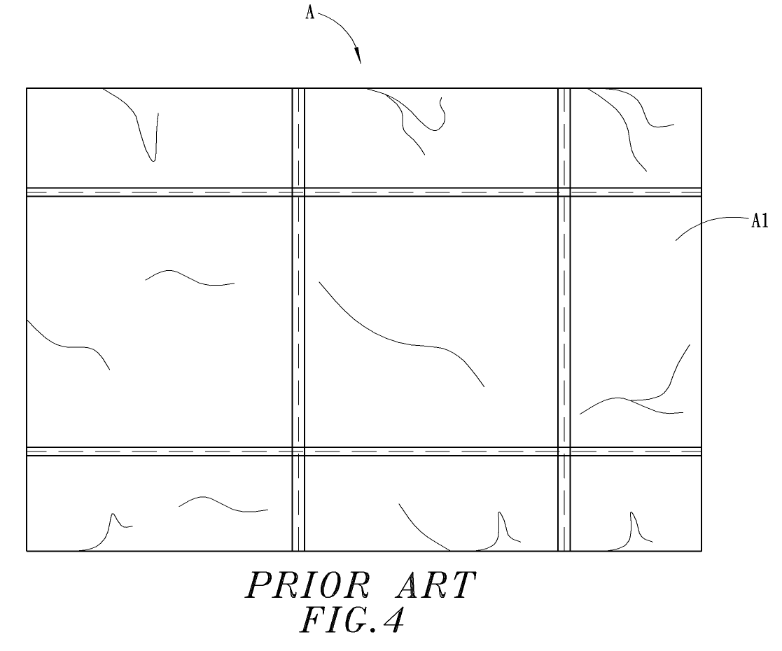

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

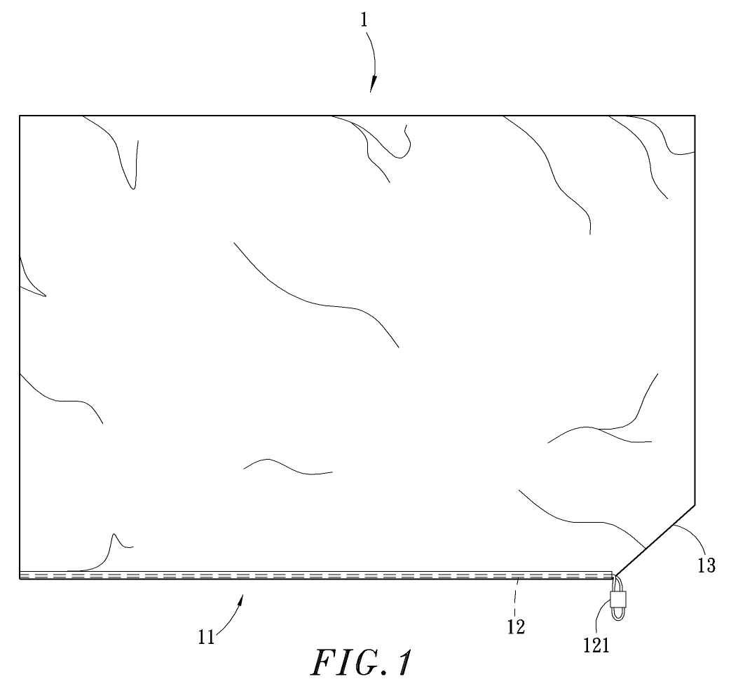

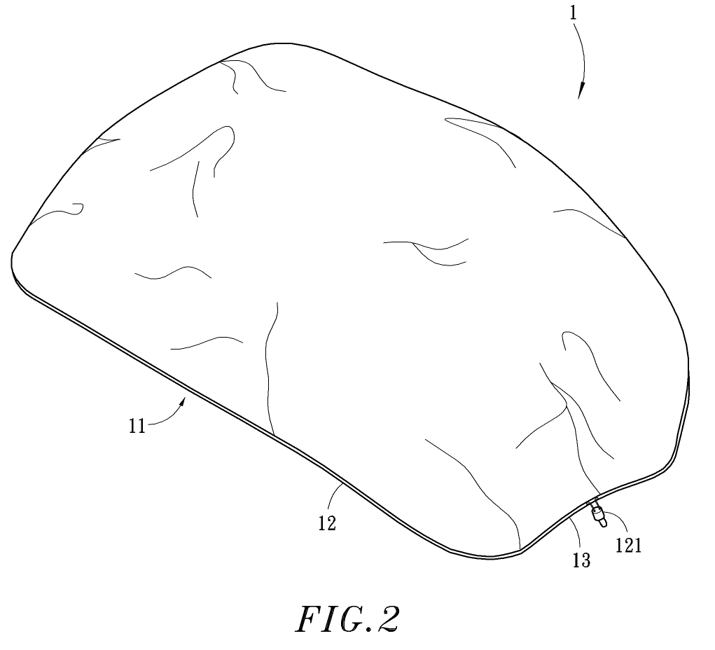

Referring FIGS. 1 and 2, the car dust cover 1 is comprised of a single-piece high density PE material having an opening 11 and a fastening element 12. A slope 13 is formed at a side of the fastening element 12 for the tightening portion 121 of the fastening element 12 to protrude out.

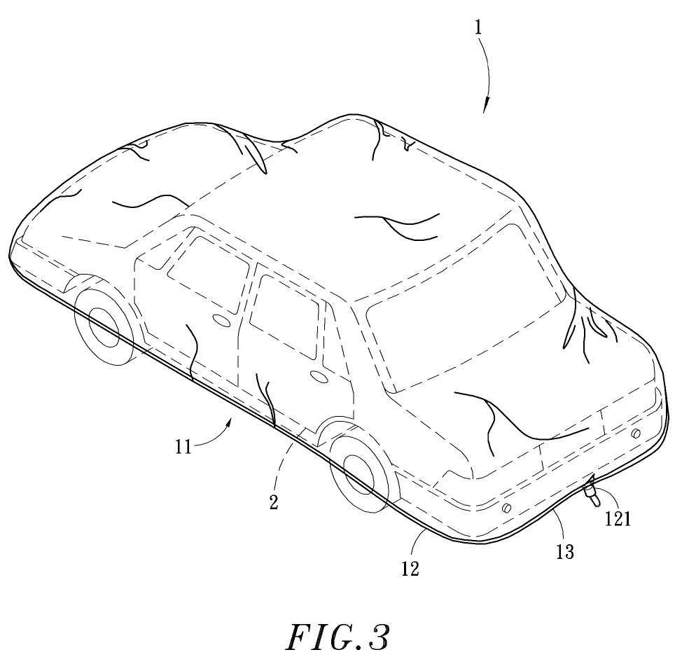

Referring to FIG. 3, a prospective view of the car dust cover covering a car according to an embodiment of the present invention is shown. As shown, after the top the car dust cover 1 covers the car 2, the opening 11 is then tightened by the tightening portion 121 of the fastening element 12, thus the car 2 can be effectively covered within the car dust cover 1 for substantially keeping out dust and water.

The car dust cover 1 of the present invention is suitable for any kind of cars, and has at least the following advantages.

The car dust cover 1 is comprised of a single-piece high density PE material without sewing, therefore the manufacturing cost thereof can be reduced.

The car dust cover 1 is made of a single-piece, and therefore do not require sewing. Therefore, the problem of dust and water penetrating through the slit can be effectively avoided. Thus, the car 2 can be maintained cleaner.

The car dust cover 1 is made of a single-piece, and therefore the problem of stretching or tearing after long reuse can be effectively avoided.

The car dust cover 1 is made of a single-piece and can be closely in contact with the car, thus car dust cover 1 can substantially keep out dust and water.

The car dust cover 1 is made of high density PE material, and therefore the manufacturing cost can be accordingly reduced.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and nonlimiting sense.

1. A car dust cover, made of a single-piece high density PE material comprises an opening and a fastening element at a bottom portion thereof for covering a car.

2. The car dust cover according to claim 1, wherein said fastening element has a slope at a side thereof.
